(19) United States
(12) Patent Application Publication
(10) Pub. No.: US 2022/0256560 A1
(43) Pub. Date: Aug. 11, 2022

(54) DATA TRANSMISSION METHOD, SYSTEM, COMPUTER DEVICE, AND STORAGE MEDIUM

(71) Applicant: COMBA NETWORK SYSTEMS COMPANY LIMITED, Guangzhou (CN)

(72) Inventors: Zhen LIU, Guangzhou (CN); Huijun XU, Guangzhou (CN); Yang OU, Guangzhou (CN); Bo YANG, Guangzhou (CN); Baoguo DING, Guangzhou (CN); Pengfei HUANG, Guangzhou (CN)

(73) Assignee: COMBA NETWORK SYSTEMS COMPANY LIMITED, Guangzhou (CN)

(21) Appl. No.: 17/622,329

(22) PCT Filed: Dec. 9, 2019
(86) PCT No.: PCT/CN2019/123860

§ 371 Date: Dec. 23, 2021

(30) Foreign Application Priority Data
Jun. 24, 2019 (CN) 201910548469.1

(51) Int. Cl. H04W 72/12

(52) U.S. Cl. CPC H04W 72/1231

(57) ABSTRACT

The present application relates to a data transmission method, a system, a computer device, and a storage medium. Since a target extension unit is an extension unit connected to a service distal end unit of a matching user equipment set, when data is transmitted between a host unit and a user equipment, data only needs to be transmitted to a service distal end unit group connected to the target extension unit by means of the target extension unit, and data transmission is not needed to be performed with all distal end unit groups, so that a fronthaul bandwidth between the host unit and the extension unit/distal end unit is greatly decreased, thereby reducing design costs of a baseband of the host unit. In addition, the host unit pre-matches the user equipment which can share the same time frequency resource. Therefore, the same time frequency resource only needs to be allocated to the matching user equipment set, which greatly improves the utilization rate of an air interface resource.

### TECHNICAL FIELD

The present application relates to the field of mobile communication technologies, and in particular, to a data transmission method, a system, a computer device and a storage medium.

### BACKGROUND

A distributed pico base station is a new indoor wireless distribution system for indoor wiring of optical fibers or Category 5, which adopts a structure of base band unit (BBU) and remote radio unit (RRU). The system architecture of the distributed pico base station is formed by a host unit, an extension unit and a remote unit. Based on a Third Generation Partnership Project (3GPP) protocol, a plurality of options is proposed as reference for function division between the BBU and the RRU. That is, in the prior art, function division is performed for the host unit and the remote unit/remote unit based on option8, then the host unit completes modulation and demodulation of baseband signals, the extension unit is responsible for forwarding and converging uplink and downlink signals, and the remote unit receives/sends uplink and downlink radio frequency (RF) signals, so as to achieve continuous coverage of an indoor environment. Such architecture has been widely used.

In order to reduce noise floor rise after DP RF combination, the number of DP RF combination is generally required to be limited. In a case that a larger bandwidth and a larger antenna number are required, if the division manner of option8 is still used, aforwarding bandwidth may be doubled, and baseband design costs of the host unit may be increased. For example, in a 100 MHz/4T4R indoor distribution system, the remote unit is down linked to 16 remote units, and a maximum number of RF combination of the remote units is no more than 4, then the forwarding bandwidth in an option8 division manner reaches 38.9 Gbps, while the forwarding bandwidth in an LIE 20 MHz/2T2R system is only 3.1 Gbps.

Therefore, how to reduce the forwarding bandwidth and save the baseband design costs of the host unit is a to-be-urgently-solved technical problem.

### SUMMARY

In view of the above, there is a need to provide a data transmission method, a system, a computer device and a storage medium with respect to the to-be-urgently-solved technical problem of how to reduce the forwarding bandwidth and save the baseband design costs of the host unit for 5G distributed indoor distribution architecture.

In a first aspect, according to embodiments of the present application, a data transmission method is provided, the method including:

acquiring service remote unit groups of a plurality of user equipments (UEs);

matching, according to the service remote unit groups, UEs meeting a preset time-frequency multiplexing condition to obtain a matched UE set; and

transmitting scheduling information of the matched UE set to a target extension unit, the target extension unit representing an extension unit connected to the service remote unit group of the matched UE set, and the scheduling information including time-frequency resource information and used for instructing the target extension unit to transmit data to the matched UE set and a host unit according to the time-frequency resource information.

In an embodiment, said matching, according to the service remote unit groups, UEs meeting a preset time-frequency multiplexing condition to obtain a matched UE set includes:

acquiring spatial distances between the service remote unit groups of the UEs; and

matching the UEs corresponding to the service remote unit groups of which the spatial distances are greater than a preset distance threshold, to obtain the matched UE set.

In an embodiment, the scheduling information includes downlink scheduling information and downlink service data of the matched UE set; the downlink scheduling information includes downlink time-frequency resource information allocated to the matched UE set; and the scheduling information is used for instructing the target extension unit to perform full physical layer protocol processing on the downlink service data according to downlink time-frequency resource positions, and to transmit the processed downlink service data to the matched UE set through the service remote unit group of the matched UE set.

In an embodiment, the downlink scheduling information further includes an identifier of the service remote unit group of the matched UE set.

In an embodiment, the scheduling information includes uplink scheduling information of the matched UE set; the uplink scheduling information includes uplink time-frequency resource information allocated to the UEs; and the uplink scheduling information is used for instructing the target extension unit to perform full physical layer protocol processing on uplink service data of the matched UE set according to the uplink time-frequency resource information, and to transmit the processed uplink service data back to the host unit.

In an embodiment, the target extension unit and the host unit are in communication connection through an enhanced common public radio interface (eCPRI).

In an embodiment, said acquiring service remote unit groups of a plurality of UEs includes:

acquiring signal quality data of a plurality of remote unit groups, and selecting maximum signal quality data therefrom; each of the remote unit groups including a plurality of remote units;

comparing the maximum signal quality data with a preset signal quality threshold, to obtain a comparison result; and

determining the service remote unit groups of the UEs according to the comparison result.

In an embodiment, said determining the service remote unit groups of the UEs according to the comparison result includes:

determining, if the comparison result is the maximum signal quality data being greater than the preset signal quality threshold, remote unit groups corresponding to the maximum signal quality data as the service remote unit groups of the UEs; and

determining, if the comparison result is the maximum signal quality data being greater than the preset signal quality threshold, remote unit groups corresponding to the maximum signal quality data as the service remote unit groups of the UEs; and

In an embodiment, the signal quality data is preamble data acquired through a physical random access channel (PRACH) or sounding reference signal (SRS) data.

In a second aspect, according to embodiments of the present application, a data transmission method is provided, the method including:

receiving scheduling information of a matched UE set sent by a host unit, the matched UE set including UEs matched according to a preset time-frequency multiplexing condition, and the scheduling information including time-frequency resource information allocated to the matched UE set; and

transmitting data between the matched UE set and the host unit according to the time-frequency resource information.

In an embodiment, the scheduling information includes downlink scheduling information and downlink service data of the matched UE set, and the downlink scheduling information of the matched UE set includes downlink time-frequency resource information allocated to the matched UE set; and

said transmitting data between the matched UE set and the host unit according to the time-frequency resource information includes:

performing full physical layer protocol processing on the downlink service data according to the downlink time-frequency resource information, to obtain processed downlink service data; and

transmitting the processed downlink service data to the matched UE set through a service remote unit group.

In an embodiment, the downlink scheduling information of the matched UE set further includes an identifier of the service remote unit group.

In an embodiment, the scheduling information of the matched UE set includes uplink scheduling information of the matched UE set, and the uplink scheduling information includes uplink time-frequency resource information allocated to the UEs; and

said transmitting data between the matched UE set and the host unit according to the time-frequency resource information includes:

performing physical layer protocol processing on uplink service data of the matched UE set according to the uplink time-frequency resource information, to obtain processed uplink service data; and

transmitting the processed uplink service data back to the host unit.

In an embodiment, the target extension unit and the host unit are in communication connection through an eCPRI.

In a third aspect, according to embodiments of the present application, a base station system is provided, the system including: a host unit, an extension unit and a remote unit. The host unit is connected to at least one extension unit, each of the at least one extension unit is connected to a plurality of remote unit groups, and each of the plurality of remote unit groups includes at least one remote unit.

The host unit is configured to: acquire service remote unit groups of UEs; match, according to the service remote unit groups, UEs meeting a preset time-frequency multiplexing condition to obtain a matched UE set; and transmit scheduling information of the matched UE set to a target extension unit. The target extension unit represents an extension unit connected to the service remote unit group of the matched UE set. The scheduling information includes time-frequency resource information and is used for instructing the target extension unit to transmit data to the matched UE set and a host unit according to the time-frequency resource information;

The extension unit is configured to receive the scheduling information of the matched UE set sent by the host unit, and transmit data between the matched UE set and the host unit according to the time-frequency resource information in the scheduling information.

The remote unit is configured to implement an RF signal transmitting and receiving function.

In an embodiment, the extension unit is specifically configured to perform full physical layer processing on service data of the matched UE set according to the time-frequency resource information, and transmit data to the matched UE set and the host unit according to the processed service data.

In an embodiment, the host unit and the extension unit perform data transmission by using an eCPRI, and the extension unit and the remote unit perform data transmission by using a CPRI.

In an embodiment, the host unit includes a UE position management subsystem, an eCPRI subsystem and a scheduling subsystem.

The UE position management subsystem is configured to position the service remote unit groups of the UEs and process data transmitted by a physical layer subsystem in the extension unit.

The eCPRI subsystem is configured to normalize parsing and encapsulation of protocol data through an eCPRI and transmit data with the extension unit through an eCPRI specification.

The scheduling subsystem is configured to manage and schedule air interface resources.

In an embodiment, the extension unit includes a remote unit group management subsystem, an eCPRI subsystem and a full physical layer subsystem.

The remote unit group management subsystem is configured to perform remote unit group management of uplink service data and downlink service data for the scheduling information on the side of the host unit.

The eCPRI subsystem is configured for data transmission between the host unit and the extension unit.

The full physical layer subsystem is configured to implement all physical layer functions.

In an embodiment, the service remote unit group of the UE and the extension unit are connected in a matching cascade manner according to position information of the UE.

In a fourth aspect, according to embodiments of the present application, a computer device is provided, including a memory and a processor, the memory storing a computer program. The processor, when executing the computer program, performs steps of either of the methods according to the embodiments in the first aspect and the embodiments in the second aspect.

In a fifth aspect, according to embodiments of the present application, a computer-readable storage medium storing a computer program is provided. When the computer program is executed by a processor, steps of either of the methods according to the embodiments in the first aspect and the embodiments in the second aspect are performed.

In the data transmission method, the system, the computer device and the storage medium according to the embodiments of the present application, the host unit performs data transmission with an extension unit (i.e., the target extension unit) connected to the service remote unit of the matched UE set. In this way, when transmitting data to the UE, the host unit is required only to transmit the data to the service remote unit group connected thereto through the target extension unit and then to the UE, instead of the host unit transmitting the data to all remote unit groups. As a result, a forwarding bandwidth between the host unit and the extension unit/remote unit is greatly reduced, thereby reducing baseband design costs of the host unit. Besides, the host unit matches, in advance, UEs that can share same time-frequency resources, and is required only to allocate the same time-frequency resources to the matched UE set. As a result, the utilization of air interface resources is greatly improved.

### BRIEF DESCRIPTION OF THE DRAWINGS

FIG. 1 is a diagram illustrating an application environment of a data transmission method according to an embodiment;

FIG. 2 is a flow diagram illustrating a data transmission method according to an embodiment;

FIG. 3 is a flow diagram illustrating a data transmission method according to an embodiment;

FIG. 4 is a flow diagram illustrating a data transmission method according to an embodiment;

FIG. 5 is a flow diagram illustrating a data transmission method according to an embodiment;

FIG. 6 is a flow diagram illustrating a data transmission method according to an embodiment;

FIG. 7 is a flow diagram illustrating a data transmission method according to an embodiment;

FIG. 8 is an interaction diagram illustrating a data transmission method according to an embodiment;

FIG. 9 is a schematic diagram illustrating BBU-RRU function division provided by a 3GPP protocol;

FIG. 10 is a schematic diagram illustrating a base station subsystem according to an embodiment;

FIG. 11 is a schematic diagram illustrating function division of a host unit according to an embodiment;

FIG. 12 is a schematic diagram illustrating a cascade manner of extension units according to an embodiment; and

FIG. 13 is a diagram illustrating an internal structure of a computer device according to an embodiment.

### DETAILED DESCRIPTION OF THE EMBODIMENTS

In order to make the objectives, technical solutions and advantages of the present application more comprehensible, the present application is described in further detail below with reference to the accompanying drawings and embodiments. It is to be understood that specific embodiments described herein are intended only to interpret and not to limit the present application.

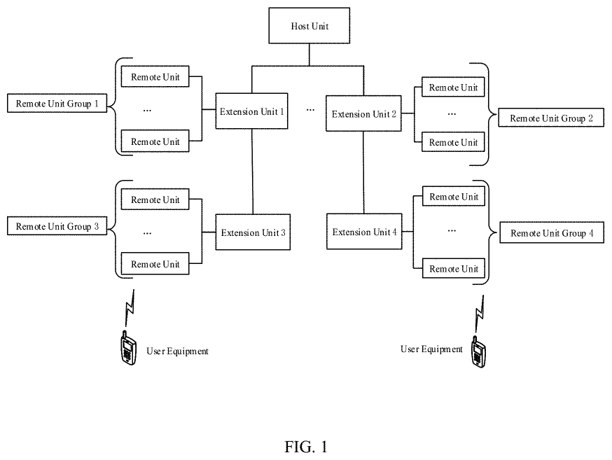

A data transmission method according to the present application may be applied to a base station system shown in FIG. 1. The system includes a host unit, extension units and remote units. The host unit is connected to a plurality of extension units, and each extension unit is in communication with at least one remote unit. The plurality of extension units may be in a parallel relation, for example, an extension unit 1 and an extension unit 2, or in a cascade relation, for example, the extension unit 1 and an extension unit 3. All remote units connected to a same extension unit may form one remote unit group, and the remote units connected to the same extension unit may also be combined to form a plurality of remote unit groups. Each extension unit may be connected to at least one remote unit group (not limited to one remote unit group shown in FIG. 1), for example, a remote unit group 1 connected to the extension unit 1. Each remote unit group may include at least one remote unit. The host unit mainly completes modulation and demodulation of baseband signals, the extension unit mainly completes forwarding and convergence of uplink/downlink signals, and the remote unit mainly completes RF receiving/RF transmission of uplink/downlink signals. Generally, the host unit is in communication connection with a core network, and the remote unit is in communication connection with user equipment (UE). Therefore, the base station system may realize communication between the host unit and the UE, communication between the core network and the UE, communication between the UEs, and so on. The UE may be, but is not limited to, devices with a RF receiving/transmission function such as smart phones, computer devices, portable wearable devices, Internet of Things devices, vehicles, unmanned aerial vehicles, and industrial devices.

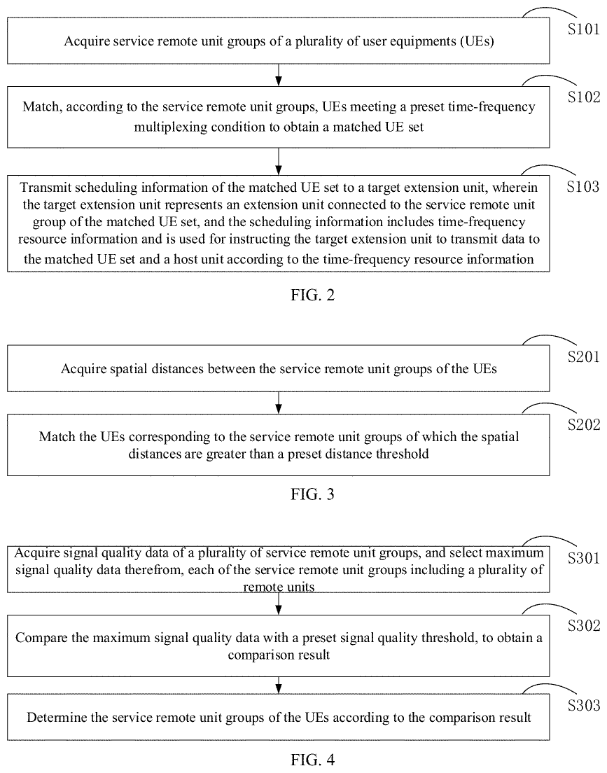

According to embodiments of the present application, a data transmission method, a system, a computer device and a storage medium are provided to solve the technical problem of how to reduce the forwarding bandwidth and save the baseband design costs of the host unit for 5G distributed indoor distribution architecture. The technical solutions of the present application and how the technical solutions of the present application solve the above technical problems will be specifically described in detail below through embodiments in conjunction with the accompanying drawings. The following embodiments may be combined with each other. Identical or similar concepts or processes may not be repeated in some embodiments. It is to be noted that the data transmission method according to the present invention is performed by a host unit in FIG. 2 to FIG. 4, but is performed by an extension unit in FIG. 5 to FIG. 7. In FIG. 2 to FIG. 7, the method may also be performed by a data transmission apparatus which may be implemented as part or whole of data transmission through software, hardware or a combination of hardware and software.

In order to make the objectives, technical solutions and advantages of the embodiments of the present invention clearer, the technical solutions in the embodiments of the present invention will be described clearly and completely in combination with the accompanying drawings in the embodiments of the present invention. It is apparent that the embodiments described are some rather than all of the embodiments of the present invention.

Embodiments involved in which the method is performed at the side of the host unit are described in detail below.

In an embodiment, FIG. 2 provides a data transmission method. This embodiment involves a specific process in which a host unit first acquires service remote unit groups of UEs and determines a matched UE set meeting a preset time-frequency multiplexing condition, and then transmits scheduling information of the matched UE set. As shown in FIG. 2, the method includes the following steps.

In S101, service remote unit groups of a plurality of UEs are acquired.

In this embodiment, the service remote unit group of the UE represents a remote unit group serving the UE. Each service remote unit group includes a plurality of remote units. It is to be noted that the remote units included in the remote unit group may be spatially related. For example, distances therebetween are less than a preset distance threshold, or within a region of a preset size. For example, in practical application, the host unit acquiring service remote unit groups of UEs may includes first determining service remote unit groups corresponding to the UEs and then acquiring the service remote unit groups. The host unit may determine the service remote unit groups corresponding to the UEs according to position information of the UEs or in other manners, which is not limited in this embodiment. The plurality of UEs may be all or some of the UEs connected to the cell (i.e. the base station system).

In S102, UEs meeting a preset time-frequency multiplexing condition are matched according to the service remote unit groups, to obtain a matched UE set.

The host unit matches, based on the service remote unit groups of the plurality of UEs acquired in step S101, UEs meeting a preset time-frequency multiplexing condition, to obtain a matched UE set. The matched UE set indicates a set of a plurality of UEs that share one time-frequency resource. The preset time-frequency multiplexing condition indicates a preset position relation between the service remote unit groups of the UEs. For example, in practical application, the host unit may match the UEs meeting the preset time-frequency multiplexing condition by first acquiring positions of the service remote unit groups of the UEs, then determining whether the position relation meets the preset time-frequency multiplexing condition, and matching the corresponding UEs if yes or in other manners, which is not limited in this embodiment.

In S103, scheduling information of the matched UE set is transmitted to a target extension unit. The target extension unit represents an extension unit connected to the service remote unit group of the matched UE set. The scheduling information includes time-frequency resource information and is used for instructing the target extension unit to transmit data to the matched UE set and a host unit according to the time-frequency resource information.

In this step, the host unit transmits, based on the matched UE set determined in step S102, scheduling information of the matched UE set to a target extension unit. The scheduling information includes time-frequency resource information (such as time-frequency resource positions) allocated by the host unit to the matched UE set, and is used for instructing the target extension unit to transmit data to the matched UE set and the host unit according to the time-frequency resource information. The target extension unit here represents an extension unit connected to the service remote unit group of the matched UE set. It is to be noted that, since one remote unit group may be connected to a plurality of extension units, that is, the target extension unit in this embodiment is one of the extension units connected to the service remote unit group of the matched UE set, and signal quality is best on a signal transmission link between the host unit connected by the target extension unit and the matched UE set. The signal transmission link represents a link among host unit—extension unit—remote unit—UE. It may be understood that communication between the host unit and the matched UE set is conducted through the target extension unit, preventing communication with the UE through other non-target extension units, so as to improve high-quality and high-efficiency signal data transmission between the matched UE set and the host unit.

Generally, in the prior art, when communicating with the UE through the extension unit, the host unit receives data uploaded by all the remote units, and in an uplink process, an amount of uplink data received by the host unit is highly correlated with a number of all the remote unit groups. On this basis, when the extension unit performs RF combination on the data uploaded by the remote units, noise floor may rise. In order to limit the rise of the noise floor, a maximum number N of RF combination of the remote units is limited. Generally, only 4 or 8 remote units are allowed to be RF combined. Therefore, the number of the remote unit groups cannot be unlimitedly small, so that there are limitations on reducing an uplink forwarding bandwidth through RF combination of the remote unit groups. In the data transmission method according to this embodiment, the host unit performs data transmission with an extension unit (i.e., the target extension unit) connected to the service remote unit of the matched UE set. In this way, when transmitting data to the UE, the host unit is required only to transmit the data to the service remote unit group connected thereto through the target extension unit and then to the UE, instead of the host unit transmitting the data to all remote unit groups. As a result, a forwarding bandwidth between the host unit and the extension unit/remote unit is greatly reduced, thereby reducing baseband design costs of the host unit. Besides, the host unit matches, in advance, UEs that can share same time-frequency resources, and is required only to allocate the same time-frequency resources to the matched UE set. As a result, the utilization of air interface resources is greatly improved.

On the basis of the above embodiment, an embodiment of the present application further provides a data transmission method, which involves a specific process in which the host unit matches UEs meeting a preset time-frequency multiplexing condition. As shown in FIG. 3, step S102 includes the following steps.

In S201, spatial distances between the service remote unit groups of the UE are acquired.

In this embodiment, the host unit acquires spatial distances between the service remote unit groups of the UE. For example, the host unit may acquire the spatial distances by acquiring coordinate information of central points of the service remote unit groups of the UE and then determining the spatial distances between the service remote unit groups according to the coordinate information.

In S202, the UEs corresponding to the service remote unit groups of which the spatial distances are greater than a preset distance threshold are matched, to obtain the matched UE set.

Based on the spatial distances between the service remote unit groups of the UE acquired in step S201, the host unit compares the spatial distances with a preset distance threshold, then determines the service remote unit groups corresponding to the spatial distances greater than the preset distance threshold, and further matches the UEs corresponding to the determined service remote unit groups. In this way, the matched UEs may share same time-frequency resources. The preset distance threshold is preset according to an actual situation, a specific value of which is not limited in this embodiment.

In the data transmission method according to this embodiment, the UEs corresponding to the service remote unit groups of which the spatial distances are greater than the preset distance threshold are matched, and then same time-frequency resources are allocated to the matched UE set subsequently. In this way, when detecting that spatial isolation degrees of different user terminals meet a preset time-frequency resource multiplexing requirement, the host unit allocates the same time-frequency resources to the matched UE set meeting the condition, which greatly improves the utilization of air interface resources.

In the above embodiment, after the host unit determines the matched UE set, the process in which the host unit transmits the scheduling information of the matched UE set to the target extension unit includes an uplink scheduling process and a downlink scheduling process.

In an embodiment, for the downlink scheduling process, the scheduling information includes downlink scheduling information and downlink service data of the matched UE set. The downlink scheduling information includes downlink time-frequency resource information allocated to the matched UE set. The scheduling information is used for instructing the target extension unit to perform full physical layer protocol processing on the downlink service data according to downlink time-frequency resource positions, and to transmit the processed downlink service data to the matched UE set through the service remote unit group of the matched UE set. Optionally, the downlink scheduling information further includes an identifier of the service remote unit group of the matched UE set.

In this embodiment, the downlink scheduling process represents a data transmission process from the host unit to the matched UE set. In the process, the host unit transmits the downlink scheduling information and the downlink service data of the matched UE set to the target extension unit. After receiving the downlink scheduling information and the downlink service data, the target extension unit performs full physical layer processing on the downlink service data according to the downlink time-frequency resources carried in the downlink scheduling information and allocated by the host unit to the matched UE set, and then transmits the processed downlink service data to the matched UE set through the service remote unit group of the matched UE set. Downlink data is data to be transmitted by the host unit to the UE, such as voice data, video data, web data, and the like delivered from the core network. The full physical layer processing includes, but is not limited to, Fourier transform, channel estimation, equalization, descramble, decoding, RE demapping, and the like. The downlink scheduling information further includes an identifier of the service remote unit group of the matched UE set. That is, the target extension unit may determine the service remote unit group of the matched UE set through the identifier of the service remote unit group. The identifier is not limited in the embodiment of the present application, which may be numbers, letters or a combination of numbers and letters. In this way, the target extension unit can be quickly and efficiently positioned to the accurate service remote unit group. In addition, the target extension unit transmits the processed downlink service data to the service remote unit group through a common public radio interface (CPRI).

In another embodiment, for the uplink scheduling process, the scheduling information includes uplink scheduling information of the matched UE set. The uplink scheduling information includes uplink time-frequency resource information allocated to the UEs. The uplink scheduling information is used for instructing the target extension unit to perform full physical layer protocol processing on uplink service data according to the uplink time-frequency resource information, and to transmit the processed uplink service data back to the host unit. Optionally, the target extension unit and the host unit are in communication connection through an enhanced common public radio interface (eCPRI).

In this embodiment, the uplink scheduling process represents a data transmission process from the matched UE set to the host unit. In the process, the matched UE set uploads the uplink service data to the target extension unit through the service remote unit group. On this basis, after the host unit sends the uplink scheduling information of the matched UE set to the target extension unit, the target extension unit acquires uplink time-frequency resource information of the matched UE set according to the uplink scheduling information, then performs full physical layer processing on the uplink service data of the matched UE set according to the uplink time-frequency resource information, and transmits the processed uplink service data back to the host unit. The uplink data may be voice data, video data, web data, uplink control data, or the like. The target extension unit and the host unit are in communication connection through an eCPRI. That is, the target extension unit transmits the processed uplink service data back to the host unit through the eCPRI, which may greatly reduce a requirement on a transmission bandwidth. In this embodiment, an amount of the uplink service data received by the host unit is only a number of remote units connected to the target extension unit, so as to reduce an amount of the uplink service data transmitted, thereby reducing a requirement on an uplink forwarding bandwidth.

In the data transmission method according to this embodiment, the extension unit and the remote unit perform transmission through a CPRI, which effectively reduces design complexity and costs of the remote unit. The host unit and the extension unit perform transmission through an eCPRI, which greatly reduces the requirement on the transmission bandwidth. Moreover, during uplink and downlink data scheduling, the host unit and the extension unit cooperate to complete convergence and distribution of uplink and downlink signals, preventing further RF combination and limiting the rise of the received noise floor. In addition, in the present invention, all physical layer functions are sunk into the extension unit for implementation, and the extension unit has independent demodulation and decoding capabilities, which greatly reduces the design costs of the host unit.

It is to be additionally noted that, unique identifiers may be allocated to the UE, the matched UE set, the remote unit, the service remote unit group, the extension unit and so on during downlink or uplink data transmission, so as to ensure accuracy and efficiency of data transmission during transmission of uplink and downlink data. For example, the remote unit group has a group identifier, the UE may have a unique intra-cell identifier, and so on. In practical application, identifiers may be allocated as appropriate, which is not limited in this embodiment.

For the host unit acquiring service remote unit groups of a plurality of UEs, an embodiment of the present application provides a data transmission method. As shown in FIG. 4, step S101 includes the following steps.

In S301, signal quality data of a plurality of remote unit groups is acquired, and maximum signal quality data is selected therefrom. Each of the remote unit groups includes a plurality of remote units.

In this embodiment, the host unit acquires signal quality data of a plurality of remote unit groups. Optionally, the signal quality data is preamble data acquired through a physical random access channel (PRACH) or sounding reference signal (SRS) data, that is, preamble signals uploaded by the PRACH or SRS. Certainly, the signal quality data is not limited to the above two, and may also be other signals that may represent signal quality conditions between the remote unit and the UE. Maximum signal quality data is selected based on the acquired signal quality data of the plurality of remote unit groups. For example, the maximum signal quality data may be selected in descending order of the signal quality data of the remote unit groups according to signal strength, to obtain a sorting result of the signal quality data. Then, the first signal quality data is selected from the sorting result and determined as the maximum signal quality data.

In S302, the maximum signal quality data is compared with a preset signal quality threshold, to obtain a comparison result.

The host unit compares the maximum signal quality data in step S301 with a preset signal quality threshold, to obtain a comparison result. The comparison result is the maximum signal quality data being greater than the preset signal quality threshold or the maximum signal quality data being less than or equal to the preset signal quality threshold. In this embodiment, the case where the two are equal is classified as the case where the maximum signal quality data is less than the preset signal quality threshold. Therefore, if the two are equal, the case is performed according to the solution that the maximum signal quality data is less than the preset signal quality threshold.

In S303, the service remote unit groups of the UEs are determined according to the comparison result.

The service remote unit groups of the UEs are determined based on the comparison result between the maximum signal quality data and the preset signal quality threshold in step S302. In practical application, the host unit determines the service remote unit groups of the UEs according to the comparison result in a specific implementation manner as provided below in this embodiment.

Optionally, the implementation manner of S303 includes a solution A and a solution B.

In the solution A, if the comparison result is the maximum signal quality data being greater than the preset signal quality threshold, remote unit groups corresponding to the maximum signal quality data are determined as the service remote unit groups of the UEs.

In this solution, the case where the comparison result is the maximum signal quality data being greater than the preset signal quality threshold indicates that a remote unit group with good signal quality exists, and the host unit determines the remote unit groups corresponding to the maximum signal quality data (data with the best signal quality) as the service remote unit groups of the UEs. In this way, the remote unit groups corresponding to the best signal quality are selected to ensure efficient and high-quality transmission of data.

In the solution B, determining, if the comparison result is the maximum signal quality data being less than the preset signal quality threshold, remote unit groups corresponding to two pieces of maximum signal quality data are determined as the service remote unit groups of the UEs.

In this solution, the case where the comparison result is the maximum signal quality data being less than (including equal to) the preset signal quality threshold indicates that signal quality of the remote unit groups is not good. In this case, the host unit determines the remote unit groups corresponding to the first two pieces of signal quality data as the service remote unit groups of the UEs. That is, when the signal quality of the remote unit groups fails to reach the preset signal quality threshold, two service remote unit groups are selected to ensure normal data transmission.

In the data transmission method according to this embodiment, the host unit determines different service remote unit groups for the UEs according to different signal quality conditions of the remote unit groups, so as to ensure that the selected service remote unit groups can efficiently serve, with high quality, data transmission between the UEs and the host unit.

Embodiments involved in which the method is performed at the side of the target extension unit are described in detail below. It is to be noted that, since repeated terms, steps or beneficial effects exist between the embodiments of the side of the target extension unit and the embodiments of the side of the host unit, such repeated parts that have been described in the embodiments of the side of the host unit will not be repeated in the embodiments of the side of the target extension unit.

In an embodiment, FIG. 5 provides a data transmission method. This embodiment involves a specific process in which a target extension unit transmits data between a matched UE set and a host unit according to scheduling information carrying time-frequency resource information of the matched UE set and sent by the host unit. As shown in FIG. 5, the method includes the following steps.

In S401, scheduling information of a matched UE set sent by a host unit is received. The matched UE set includes UEs matched according to a preset time-frequency multiplexing condition. The scheduling information includes time-frequency resource information allocated to the matched UE set.

In this embodiment, the extension unit (target extension unit) receives scheduling information of a matched UE set sent by a host unit. The matched UE set includes UEs matched by the host unit according to a preset time-frequency multiplexing condition, indicating UEs that may share same time-frequency resources. The scheduling information includes time-frequency resource information allocated by the host unit to the matched UE set.

In S402, data is transmitted between the matched UE set and the host unit according to the time-frequency resource information.

Based on the scheduling information received in step S401, the target extension unit transmits data between the UE and the host unit according to the time-frequency resource information in the scheduling information. For example, the target extension unit may process uplink service data of the UE or downlink service data delivered by the host unit according to the time-frequency resource information, and then transmit the processed data to the UE or the host unit.

In the data transmission method according to this embodiment, since the target extension unit executing the method represents an extension unit connected to a service remote unit group of the matched UE set, in this way, after the target extension unit receives scheduling information of the matched UE set sent by the host unit first, the target extension unit, when transmitting data between the matched UE and the host unit according to the time-frequency resource information carried in the scheduling information, is required only to transmit the data through the service remote unit group connected thereto, instead of transmitting the data to all remote unit groups, so that a forwarding bandwidth between the host unit and the extension unit/remote unit is greatly reduced, thereby reducing baseband design costs of the host unit. Besides, the host unit matches, in advance, scheduling information of UEs that can share same time-frequency resources, and is required only to allocate the same time-frequency resources to the matched UE set, which greatly improves the utilization of air interface resources.

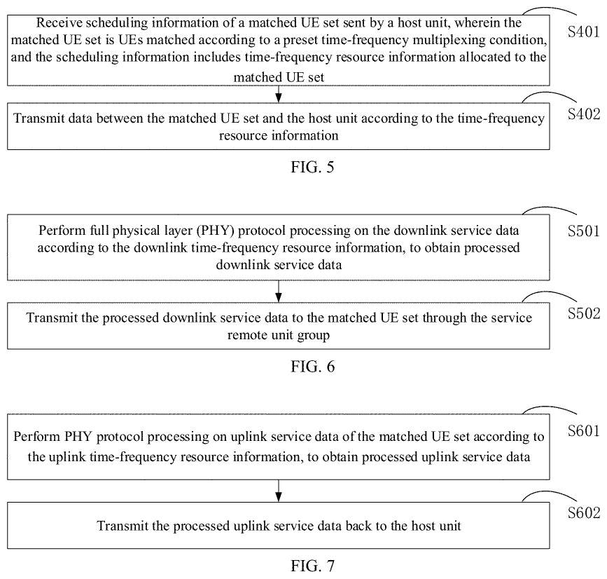

On the basis of the above embodiment, one embodiment is provided, in which, as shown in FIG. 6, if the scheduling information includes downlink scheduling information and downlink service data of the matched UE set, and the downlink scheduling information of the matched UE set includes downlink time-frequency resource information allocated to the matched UE set, step S402 includes the following steps.

In S501, full physical layer protocol processing is performed on the downlink service data according to the downlink time-frequency resource information, to obtain processed downlink service data.

In this embodiment, the target extension unit, after receiving the scheduling information transmitted by the host unit, performs full physical layer protocol processing on the downlink service data of the matched UE set according to the downlink time-frequency resource information in the scheduling information, to obtain processed downlink service data. The full physical layer processing includes, but is not limited to, Fourier transform, channel estimation, equalization, descramble, decoding, RE demapping, and the like.

In S502, the processed downlink service data is transmitted to the matched UE set through the service remote unit group.

In this step, based on the processed downlink service data obtained in step S501, the target extension unit transmits the processed downlink service data to the matched UE set through the service remote unit group. Optionally, the downlink scheduling information of the matched UE set further includes an identifier of the service remote unit group. Specifically, the target extension unit may determine the service remote unit group of the matched UE set through the identifier of the service remote unit group. The identifier is not limited in the embodiment of the present application, which may be numbers, letters or a combination of numbers and letters. In this way, the target extension unit can be quickly and efficiently positioned to the accurate service remote unit group. In addition, the target extension unit transmits the processed downlink service data to the service remote unit group through a CPRI.

In another embodiment, as shown in FIG. 7, if the scheduling information of the matched UE set includes uplink scheduling information of the matched UE set, and the uplink scheduling information includes uplink time-frequency resource information allocated to the UEs, step S402 includes the following steps.

In S601, full physical layer protocol processing is performed on uplink service data of the matched UE set according to the uplink time-frequency resource information, to obtain processed uplink service data.

In this embodiment, the target extension unit, after receiving the scheduling information transmitted by the host unit, performs full physical layer protocol processing on the uplink service data of the matched UE set according to the uplink time-frequency resource information in the scheduling information, to obtain processed uplink service data. In a case that the matched UE set uploads the uplink service data to the target extension unit through the service remote unit group, the uplink service data of the UE is stored in the target extension unit. Besides, each remote unit may receive an uplink signal sent by the UE. The extension unit may receive an uplink signal sent by each remote unit connected to the extension unit, and performs RF combination, which is equivalent to signal superimposition and may increase a signal-to-noise ratio, on the uplink signals belonging to a same remote unit group, to obtain an uplink signal of each remote unit group after the RF combination. The uplink signal may indicate signal quality conditions between the remote unit groups connected to the extension unit and the UEs. The full physical layer processing includes, but is not limited to, Fourier transform, channel estimation, equalization, descramble, decoding, RE demapping, and the like.

In S602, the processed uplink service data is transmitted back to the host unit.

In this step, the target processing unit transmits the processed uplink service data of the matched UE set in step S601 back to the host unit. Optionally, the target extension unit and the host unit are in communication connection through an eCPRI. Specifically, the target extension unit transmits the processed uplink service data back to the host unit through the eCPRI. It may be understood that, in the embodiment of the present application, the host unit transits the scheduling information to the target extension unit also through the eCPRI.

In the data transmission method according to this embodiment, the extension unit and the remote unit perform transmission through a CPRI, which effectively reduces design complexity and costs of the remote unit. The host unit and the extension unit perform transmission through an eCPRI, which greatly reduces the requirement on the transmission bandwidth. In addition, in the present invention, all physical layer functions are sunk into the extension unit for implementation, and the extension unit has independent demodulation and decoding capabilities, which greatly reduces the design costs of the host unit.

It should be understood that, although the steps in the flows of FIG. 2 to FIG. 7 are displayed in sequence as indicated by the arrows, the steps are not necessarily performed in the order indicated by the arrows. Unless otherwise clearly specified herein, the steps are performed without any strict sequence limitation, and may be performed in other orders. In addition, at least some steps in FIG. 2 to FIG. 7 may include a plurality of sub-steps or a plurality of stages, and such sub-steps or stages are not necessarily performed at a same moment, and may be performed at different moments. The sub-steps or stages are not necessarily performed in sequence, and the sub-steps or stages and at least some of other steps or sub-steps or stages of other steps may be performed in turn or alternately.

In addition, an embodiment of the present application further provides a base station system. The system includes a host unit, an extension unit and a remote unit. The host unit is connected to at least one extension unit, and each extension unit is connected to a plurality of remote unit groups. Each of the remote unit groups includes at least one remote unit. The host unit is configured to: acquire service remote unit groups of UEs; match, according to the service remote unit groups, UEs meeting a preset time-frequency multiplexing condition to obtain a matched UE set; and transmit scheduling information of the matched UE set to a target extension unit. The target extension unit represents an extension unit connected to the service remote unit group of the matched UE set. The scheduling information includes time-frequency resource information and is used for instructing the target extension unit to transmit data to the matched UE set and the host unit according to the time-frequency resource information. The extension unit is configured to receive the scheduling information of the matched UE set sent by the host unit, and transmit data between the matched UE set and the host unit according to the time-frequency resource information in the scheduling information. The remote unit is configured to implement an RF signal transmitting and receiving function. Optionally, the extension unit is specifically configured to perform full physical layer processing on service data of the matched UE set according to the time-frequency resource information, and transmit data to the matched UE set and the host unit according to the processed service data. Optionally, the host unit and the extension unit perform data transmission by using an eCPRI; and the extension unit and the remote unit perform data transmission by using a CPRI.

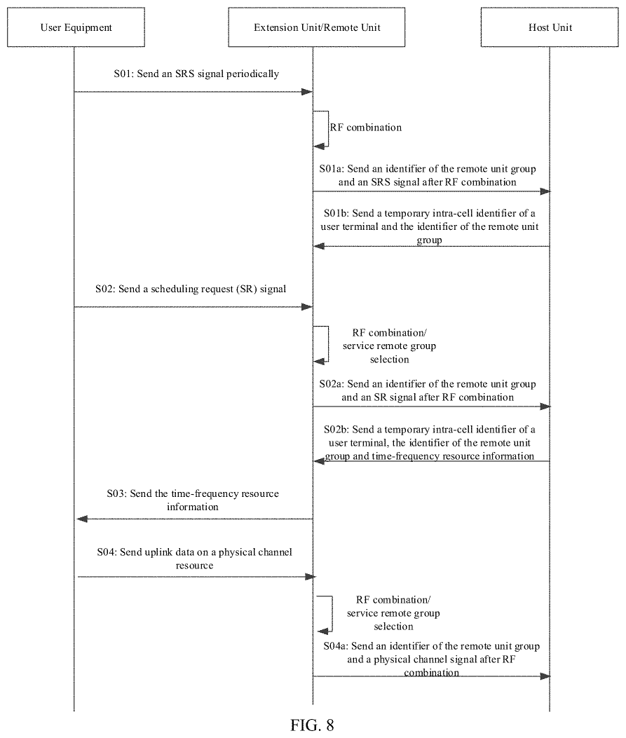

In this embodiment, referring to the base station system shown in FIG. 1, if the extension unit connected to the host unit is connected to M remote units, where N remote units form a remote unit group, the base station system includes a total of K=[M/N] remote unit groups. If the host unit communicates with the UE through L extension units, based on the base station system, an embodiment of the present application provides an embodiment of a data transmission process. As shown in FIG. 8, the data transmission process includes the following steps.

In S01, the UE sends an SRS signal periodically.

Specifically, the remote unit, after receiving an SRS radio frequency (RF) signal, sends the SRS RF signal to the extension unit, and the extension unit performs RF combination on the received SRS RF signal. A number of the RF combination is configured through an operation administration and maintenance (OAM) subsystem. The extension unit performs full physical layer processing on the SRS RF signal after RF combination, to obtain SRS bit-level data.

In S01a, the extension unit sends the SRS bit-level data to the host unit, and at the same time, carries an identifier of the remote unit group after RF combination.

In S01b, the host unit, after receiving SRS demodulation data of a plurality of remote unit groups, selects one of the remote unit groups with a maximum SRS signal-to-noise ratio as a first service remote unit group of the UE.

Optionally, if the SRS signal-to-noise ratio of the UE is lower than a threshold, the host unit selects two remote unit groups with the best signal quality as a first service remote unit group and a second service remote unit group of the UE respectively. The host unit delivers a temporary intra-cell identifier of the UE and identifiers of the first and second service remote unit groups to the corresponding extension units.

In S02, the UE sends a scheduling request (SR) to request a network to allocate uplink resources.

Specifically, this step is the same as S01. The extension unit performs RF combination after receiving an SR RF signal. A signal of the SR is carried by a physical uplink control channel (PUCCH). A number of the RF combination is configured through the OAM subsystem. The extension unit performs full physical layer processing on the SR RF signal after RF combination, to obtain SR PUCCH Bit data.

In S02a, the extension unit sends the SR PUCCH Bit data to the host unit, and at the same time, carries an identifier of the remote unit group after RF combination.

In S02b, the host unit, after receiving the SR PUCCH Bit data, notifies a media access control address (MAC) subsystem to allocate uplink resources. The host unit delivers a temporary intra-cell identifier of the UE, the identifier of the remote unit group and time-frequency resource information to the corresponding extension units. The time-frequency resource information includes an uplink resource allocation result of the UE, such as time-frequency resource position information of a physical uplink shared channel (PUSCH).

In S03, the extension unit directly transparently transmits the time-frequency resource information to the UE.

In S04, the UE sends uplink data on a PUSCH resource specified by the time-frequency resource information.

Specifically, the extension unit, after receiving a PUSCH RF signal, performs RF combination. The number of RF combination is configured through the OAM subsystem. The extension unit performs full physical layer processing on the PUSCH RF signal after RF combination, to obtain PUSCH bit-level data.

In S04a, the extension unit sends the PUSCH bit-level data to the host unit, and at the same time, carries an identifier of the remote unit group after RF combination.

Specifically, according to the service remote unit group of the UE delivered by the host unit in S01b and PUSCH time-frequency position information specified by the time-frequency resource information, the extension unit is only required to send uplink data corresponding to the remote unit group and corresponding to PUSCH time-frequency positions to the host unit. In this step, the host unit may position the UE at an intersection of two remote unit groups. In this case, the host unit delivers identifiers of two remote unit groups to the extension unit. The extension unit receives uplink data received by the two remote unit groups in diversity, and uploads the uplink data to the host unit after full physical layer processing. The host unit, if receiving multi-channel data from a same UE, selects a set of data passing CRC check and submits it to the MAC.

In the above process, the host unit demodulates an uplink SRS signal of the UE to position, in real time, a remote unit group to which the UE belongs, and delivers an identifier of the remote unit group to which the UE belongs to the corresponding extension unit. The extension unit, after receiving uplink symbol data of the corresponding UE, is required only to upload one or two remote unit group signals of the UE to the host unit, thereby reducing a requirement of the forwarding on an uplink bandwidth. In addition, in the present invention, all full physical layer functions are sunk into the extension unit for implementation and the extension unit has independent demodulation and decoding capabilities. When the host unit determines that the UE meets a requirement on an isolation degree, same time-frequency resources are allocated to different UEs through a scheduler, and different extension units independently perform demodulation and decoding, thereby freeing up the baseband computing capability of the host unit and effectively improving the utilization of air interface resources.

Based on the above embodiment, an embodiment of the present application further provides a base station system. The host unit includes a UE position management subsystem, an eCPRI subsystem and a scheduling subsystem. The UE position management subsystem is configured to position the service remote unit groups of the UEs and process data transmitted by a physical layer subsystem in the extension unit. The eCPRI subsystem is configured to normalize parsing and encapsulation of protocol data through an eCPRI and transmit data with the extension unit through an eCPRI specification. The scheduling subsystem is configured to manage and schedule air interface resources. Optionally, the extension unit includes a remote unit group management subsystem, an eCPRI subsystem and a full physical (PHY) layer subsystem. The remote unit group management subsystem is configured to perform remote unit group management of uplink service data and downlink service data for the scheduling information on the side of the host unit. The eCPRI subsystem is configured for data transmission between the host unit and the extension unit. The full physical layer subsystem is configured to implement all physical layer functions.

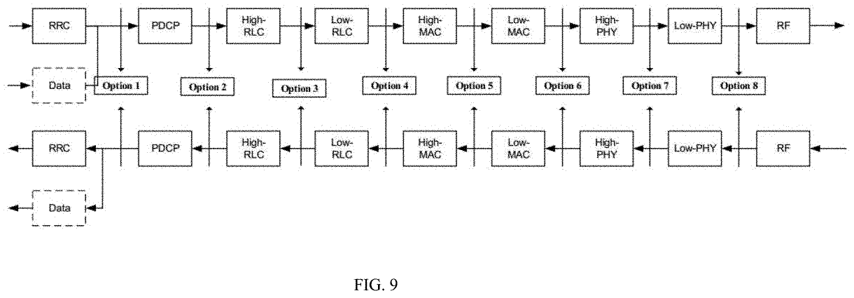

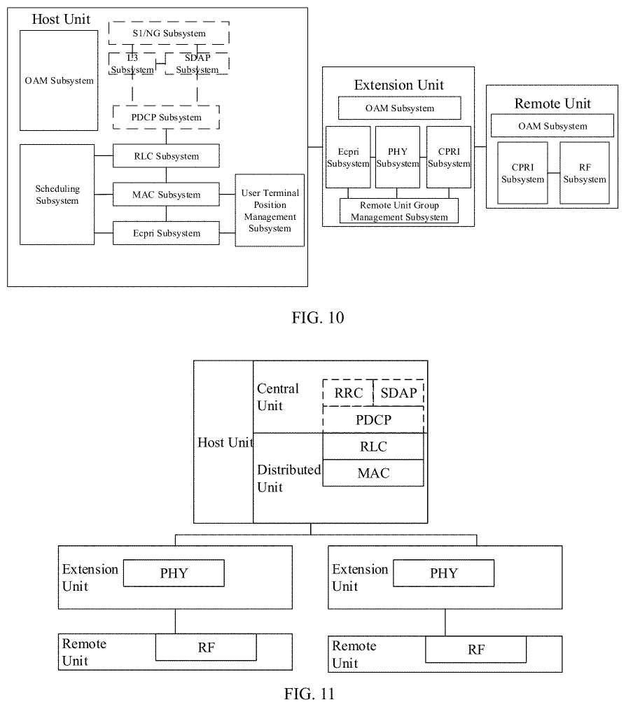

In this embodiment, referring to a schematic diagram illustrating BBU-RRU function division provided by a 3GPP protocol shown in FIG. 9, the host unit is responsible for implementing all layer functions before option6, the extension unit is responsible for implementing all physical layer functions between option6 and option8, and the remote unit is responsible for RF signal transmitting and receiving functions after option8. If the layers are classified by functions, as shown in FIG. 10, the host unit, in addition to including the UE position management subsystem, the eCPRI subsystem and the scheduling subsystem, further includes an OAM subsystem, an MAC subsystem, a radio link control (RLC) subsystem, a packet data convergence protocol (PDCP) subsystem, a service data adaptation protocol (SDAP) subsystem, a scheduling subsystem, a Layer 3 (L3) subsystem and an S1/NG interface subsystem. The scheduling subsystem, the MAC subsystem, the RLC subsystem, the PDCP subsystem, the SDAP subsystem, the scheduling subsystem, the L3 subsystem and the interface subsystem all belong to a radio access network protocol stack subsystem. The OAM subsystem is configured to manage all software, configuration, faults and performance. The MAC subsystem and the RLC subsystem are configured to process related data for the radio access network protocol stack subsystem and data transmission time interval timing. Specifically, the PDCP subsystem is configured to protect data integrity during the transmission, perform air interface encryption, and compress an Internet protocol address message header. The SDAP subsystem is configured to manage the mapping between each networking protocol address stream and a radio bearer. The scheduling subsystem is configured to manage and schedule air interface resources. The L3 subsystem is configured to process radio resource control protocol signaling and manage radio resources of a long-term evolution system. The interface subsystem is configured to process control signaling of the core network and process tunnel data.

The extension unit, in addition to including the remote unit group management subsystem, the eCPRI subsystem, and the full physical (PHY) layer subsystem, further includes a CPRI subsystem and an OAM subsystem. The full physical layer subsystem is configured to implement all full physical layer functions. The remote unit group management subsystem is configured to manage remote unit groups of uplink service data and downlink service data for the scheduling information on the side of the host unit. The eCPRI subsystem is configured for data transmission between the host unit and the extension unit. The CPRI subsystem is configured to transmit data between the remote unit and the extension unit.

The remote unit includes a CPRI subsystem, an RF subsystem and an OAM subsystem. The RF subsystem provides RF signal processing (such as analog-to-digital conversion), and transmits and receives signals through an antenna. The CPRI subsystem implements CPRI-based IQ data stream transmission with CP.

In addition, as shown in FIG. 11, the host unit may also be divided into a central unit (CU) and a distributed unit (DU). The CU is responsible for implementing PDCP, SDAP and radio resource control (RRC) layer protocol functions. The DU is responsible for implementing RLC and MAC protocol functions. The CU and the DU may be deployed together or separately.

In this way, all full physical layer functions are sunk into the extension unit for implementation, so that the extension unit has independent demodulation and decoding capabilities, thereby freeing up the baseband computing capability of the host unit and effectively improving the utilization of air interface resources.

An embodiment of the present application further provides a base station system. The system includes: a service remote unit group of a UE and an extension unit being connected in a matching cascade manner according to position information of the UE.

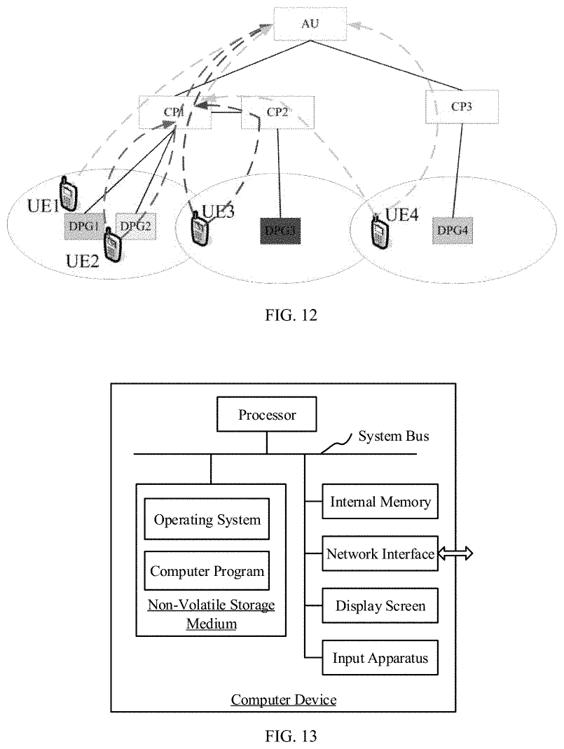

In this embodiment, the service remote unit group of the UE and the extension unit are connected in a matching cascade manner according to different position information of the UE. For example, as shown in FIG. 12, four scenarios where different UE positions correspond to different cascade manners are provided.

a) A UE is located at a central position of a remote unit group (DP group).

b) A UE is located between two remote unit groups (DP groups). The two remote unit groups are up linked to a same extension unit (CP).

c) A UE is located between two remote unit groups (DP groups). The two remote unit groups are up linked to different extension units (CPs). The extension units (CPs) are in a cascade relation.

d) A UE is located between two remote unit groups (DP groups). The two remote unit groups are up linked to different extension units (CPs). The extension units (CPs) are in a non-cascade relation.

Based on the above four scenarios, a UE data upload path corresponding to each scenario is shown in Table 1 below.

TABLE 1

| Comparative | First | Second | |
|---|---|---|---|
| item | service | service | |
| User | DP Group | DP Group | Data uplink forwarding path |
| UE1 | DP Group1 | / | DP Group1->CP1->AU |
| UE2 | DP Group1 | DP Group2 | DP Group1->CP1->AU |
| | | | DP Group2->CP1->AU |
| UE3 | DP Group2 | DP Group3 | DP Group2->CP1->AU |
| | | | DP Group3->CP2->CP1->AU |
| UE4 | DP Group3 | DP Group4 | DP Group4->CP3->AU |
| | | | DP Group3->CP2->CP1->AU |

In Table 1 above, for the UE1, the host unit (AU) positions the UE1 at a central position of the remote unit group 1 (DP Group1), and the extension unit 1 (CP1) uploads only data of the remote unit group 1 (DP Group1) to the host unit (AU) according to position information of the UE1. For the UE2 and the UE3, the host unit (AU) positions the UE2 and the UE3 in the middle of the remote unit group 1 (DP Group1)/remote unit group 2 (DP Group2) and in the middle of the remote unit group 2 (DP Group2)/remote unit group 3 (DP Group3), and the extension unit 1 (CP1) sends PUSCH symbol data corresponding to two remote unit groups (DP groups) to the host unit (AU) respectively. When receiving two signals from a same UE, the host unit (AU) may receive the two signals in diversity, improving a reception signal-to-noise ratio of the remote unit group (DP group) to an edge UE. For the UE4, the host unit (AU) positions the UE4 in the middle of the remote unit group 3 (DP Group3)/remote unit group 4 (DP Group4), and the extension unit 2 (CP2) and the extension unit 3 (CP3) upload data of one remote unit Group (DP group) to the host unit (AU) respectively. In this way, after receiving the two signals of the UE4, the host unit (AU) may receive the two signals in diversity, improving a reception signal-to-noise ratio of the remote unit group (DP group) to an edge UE.

In an embodiment, a computer device is provided. The computer device may be a terminal, and a diagram illustrating an internal structure thereof may be shown in FIG. 13. The computer device includes a processor, a memory, a network interface, a display screen, and an input apparatus that are connected through a system bus. The processor of the computer device is configured to provide computing and control capabilities. The memory of the computer device includes a non-volatile storage medium and an internal memory. The non-volatile storage medium stores an operating system and a computer program. The internal memory provides an environment for running of the operating system and the computer program in the non-volatile storage medium. The network interface of the computer device is configured to communicate with an external terminal through a network connection. The computer program is executed by the processor to perform a data transmission method. The display screen of the computer device may be a liquid crystal display screen or an electronic ink display screen. The input apparatus of the computer device may be a touch layer covering the display screen, or may be a key, a trackball, or a touchpad disposed on a housing of the computer device, or may be an external keyboard, a touchpad, a mouse, or the like.

Those skilled in the art may understand that, in the structure shown in FIG. 13, only a block diagram illustrating a partial structure related to a solution of the present application is shown, which does not constitute a limitation on the computer device to which the solution of the present application is applied. Specifically, the computer device may include more or fewer components than those shown in the figure, or some components may be combined, or a different component deployment may be used.

In an embodiment, a computer device is provided, including a memory and a processor. The memory stores a computer program. The processor, when executing the computer program, performs the following steps:

acquiring service remote unit groups of a plurality of UEs;

matching, according to the service remote unit groups, UEs meeting a preset time-frequency multiplexing condition to obtain a matched UE set; and

transmitting scheduling information of the matched UE set to a target extension unit, the target extension unit representing an extension unit connected to the service remote unit group of the matched UE set, and the scheduling information including time-frequency resource information and used for instructing the target extension unit to transmit data to the matched UE set and a host unit according to the time-frequency resource information.

Alternatively, the processor, when executing the computer program, performs the following steps:

receiving scheduling information of a matched UE set sent by a host unit, the matched UE set including UEs matched according to a preset time-frequency multiplexing condition, and the scheduling information including time-frequency resource information allocated to the matched UE set; and

transmitting data between the matched UE set and the host unit according to the time-frequency resource information.

Implementation principles and technical effects of the computer device according to the above embodiment are similar to those of the above method embodiment, which are not described in detail herein.

In an embodiment, a computer-readable storage medium storing a computer program is provided. When the computer program is executed by a processor, the following steps are performed:

acquiring service remote unit groups of a plurality of UEs;

matching, according to the service remote unit groups, UEs meeting a preset time-frequency multiplexing condition to obtain a matched UE set; and

transmitting scheduling information of the matched UE set to a target extension unit, the target extension unit representing an extension unit connected to the service remote unit group of the matched UE set, and the scheduling information including time-frequency resource information and used for instructing the target extension unit to transmit data to the matched UE set and a host unit according to the time-frequency resource information.

Alternatively, when the computer program is executed by a processor, the following steps are performed:

receiving scheduling information of a matched UE set sent by a host unit, the matched UE set including UEs matched according to a preset time-frequency multiplexing condition, and the scheduling information including time-frequency resource information allocated to the matched UE set; and

transmitting data between the matched UE set and the host unit according to the time-frequency resource information.

Implementation principles and technical effects of the computer-readable storage medium according to the above embodiment are similar to those of the above method embodiment, which are not described in detail herein.

Those of ordinary skill in the art may understand that all or some of the processes in the methods according to the above embodiments may be performed by instructing related hardware through a computer program. The computer program may be stored in a non-volatile computer-readable storage medium. The computer program, when being executed, may include the processes of the embodiments of the above methods. Any reference to a memory, a storage, a database, or other media used in the embodiments according to the present application may include a non-volatile memory and/or a volatile memory. The non-volatile memory may include a read-only memory (ROM), a programmable ROM (PROM), an electrically programmable ROM (EPROM), an electrically erasable programmable ROM (EEPROM), a flash memory, or the like. The volatile memory may include a random access memory (RAM) or an external high-speed cache memory. By way of illustration and not limitation, the RAM is available in a variety of forms, such as a static RAM (SRAM), a dynamic RAM (DRAM), a synchronous DRAM (SDRAM), a dual data rate SDRAM (DDRSDRAM), an enhanced SDRAM (ESDRAM), a synchronization link (Synchlink) DRAM (SLDRAM), a memory Bus (Rambus) direct RAM (RDRAM), a direct memory bus dynamic RAM (DRDRAM), and a memory bus dynamic RAM (RDRAM).

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only describe several implementations of the present application, and their description is specific and detailed, but cannot therefore be understood as a limitation on the patent scope of the invention. It should be noted that those of ordinary skill in the art may further make variations and improvements without departing from the conception of the present application, and these all fall within the protection scope of the present application. Therefore, the patent protection scope of the present application should be subject to the appended claims.

1. A data transmission method, comprising:
acquiring service remote unit groups of a plurality of user equipments (UEs);
matching, according to the service remote unit groups, UEs meeting a preset time-frequency multiplexing condition to obtain a matched UE set; and
transmitting scheduling information of the matched UE set to a target extension unit, wherein the target extension unit represents an extension unit connected to the service remote unit group of the matched UE set, and the scheduling information includes time-frequency resource information and is used for instructing the target extension unit to transmit data to the matched UE set and a host unit according to the time-frequency resource information.

2. The method according to claim 1, wherein said matching, according to the service remote unit groups, UEs meeting a preset time-frequency multiplexing condition to obtain a matched UE set includes:
acquiring spatial distances between the service remote unit groups of the UEs; and
matching the UEs corresponding to the service remote unit groups of which the spatial distances are greater than a preset distance threshold, to obtain the matched UE set.

3. The method according to claim 1, wherein: the scheduling information includes downlink scheduling information and downlink service data of the matched UE set; the downlink scheduling information includes downlink time-frequency resource information allocated to the matched UE set; and the scheduling information is used for instructing the target extension unit to perform full physical layer protocol processing on the downlink service data according to downlink time-frequency resource positions, and to transmit the processed downlink service data to the matched UE set through the service remote unit group of the matched UE set.

4. The method according to claim 3, wherein the downlink scheduling information further includes an identifier of the service remote unit group of the matched UE set.

5. The method according to claim 1, wherein: the scheduling information includes uplink scheduling information of the matched UE set; the uplink scheduling information includes uplink time-frequency resource information allocated to the UEs; and the uplink scheduling information is used for instructing the target extension unit to perform full physical layer protocol processing on uplink service data of the matched UE set according to the uplink time-frequency resource information, and to transmit the processed uplink service data back to the host unit.

6. The method according to claim 5, wherein the target extension unit and the host unit are in communication connection through an enhanced common public radio interface (eCPRI).

7. The method according to claim 1, wherein said acquiring service remote unit groups of a plurality of UEs includes:
acquiring signal quality data of a plurality of remote unit groups, and selecting maximum signal quality data therefrom, wherein each of the remote unit groups includes a plurality of remote units;
comparing the maximum signal quality data with a preset signal quality threshold, to obtain a comparison result; and
determining the service remote unit groups of the UEs according to the comparison result.

8. The method according to claim 7, wherein said determining the service remote unit groups of the UEs according to the comparison result includes:
determining, if the comparison result is the maximum signal quality data being greater than the preset signal quality threshold, remote unit groups corresponding to the maximum signal quality data as the service remote unit groups of the UEs; and
determining, if the comparison result is the maximum signal quality data being less than the preset signal quality threshold, remote unit groups corresponding to two pieces of maximum signal quality data as the service remote unit groups of the UEs.

9. The method according to claim 7, wherein the signal quality data is preamble data acquired through a physical random access channel (PRACH) or sounding reference signal (SRS) data.

10. A data transmission method, comprising:
receiving scheduling information of a matched UE set sent by a host unit, wherein the matched UE set includes UEs matched according to a preset time-frequency multiplexing condition, and the scheduling information includes time-frequency resource information allocated to the matched UE set; and
transmitting data between the matched UE set and the host unit according to the time-frequency resource information.

11. The method according to claim 10, wherein the scheduling information includes downlink scheduling information and downlink service data of the matched UE set, and the downlink scheduling information of the matched UE set includes downlink time-frequency resource information allocated to the matched UE set; and
wherein said transmitting data between the matched UE set and the host unit according to the time-frequency resource information includes:
performing full physical layer protocol processing on the downlink service data according to the downlink time-frequency resource information, to obtain processed downlink service data; and
transmitting the processed downlink service data to the matched UE set through a service remote unit group.

12. The method according to claim 11, wherein the downlink scheduling information of the matched UE set further includes an identifier of the service remote unit group.

13. The method according to claim 10, wherein the scheduling information of the matched UE set includes uplink scheduling information of the matched UE set, and the uplink scheduling information includes uplink time-frequency resource information allocated to the UEs; and
wherein said transmitting data between the matched UE set and the host unit according to the time-frequency resource information includes:
performing physical layer protocol processing on uplink service data of the matched UE set according to the uplink time-frequency resource information, to obtain processed uplink service data; and
transmitting the processed uplink service data back to the host unit.

14. The method according to claim 13, wherein the target extension unit and the host unit are in communication connection through an eCPRI.

15. A base station system, comprising a host unit, an extension unit and a remote unit, wherein the host unit is connected to at least one extension unit, each of the at least one extension unit is connected to a plurality of remote unit groups, and each of the plurality of remote unit groups includes at least one remote unit, and wherein:
the host unit is configured to: acquire service remote unit groups of UEs; match, according to the service remote unit groups, UEs meeting a preset time-frequency multiplexing condition to obtain a matched UE set; and transmit scheduling information of the matched UE set to a target extension unit, the target extension unit representing an extension unit connected to the service remote unit group of the matched UE set, and the scheduling information including time-frequency resource information and used for instructing the target extension unit to transmit data to the matched UE set and the host unit according to the time-frequency resource information;
the extension unit is configured to receive the scheduling information of the matched UE set sent by the host unit, and transmit data between the matched UE set and the host unit according to the time-frequency resource information in the scheduling information; and
the remote unit is configured to implement a radio frequency (RF) signal transmitting and receiving function.

16. The system according to claim 15, wherein the extension unit is specifically configured to perform full physical layer processing on service data of the matched UE set according to the time-frequency resource information, and transmit data to the matched UE set and the host unit according to the processed service data.

17. The system according to claim 15, wherein the host unit and the extension unit perform data transmission by using an eCPRI, and the extension unit and the remote unit perform data transmission by using a common public radio interface (CPRI).

18. The system according to claim 15, wherein the host unit includes a UE position management subsystem, an eCPRI subsystem and a scheduling subsystem; and
wherein: the UE position management subsystem is configured to position the service remote unit groups of the UEs and process data transmitted by a physical layer subsystem in the extension unit;
the eCPRI subsystem is configured to normalize parsing and encapsulation of protocol data through an eCPRI and transmit data with the extension unit through an eCPRI specification; and
the scheduling subsystem is configured to manage and schedule air interface resources.

19. The system according to claim 18, wherein the extension unit includes a remote unit group management subsystem, an eCPRI subsystem and a full physical layer subsystem; and
wherein: the remote unit group management subsystem is configured to perform remote unit group management of uplink service data and downlink service data for the scheduling information on the side of the host unit;
the eCPRI subsystem is configured for data transmission between the host unit and the extension unit; and
the full physical layer subsystem is configured to implement all physical layer functions.

20. The system according to claim 15, wherein the service remote unit group of the UE and the extension unit are connected in a matching cascade manner according to position information of the UE.

21-22. (canceled)
